(19) United States
(12) Patent Application Publication
(10) Pub. No.: US 2025/0197758 A1
(43) Pub. Date: Jun. 19, 2025

(54) NON-SULFONATED MELAMINE RESIN VISCOSITY REDUCER FOR DRILLING FLUID AND PREPARATION METHOD THEREOF

(71) Applicant: YANGTZE UNIVERSITY, Jingzhou City (CN)

(72) Inventors: Yu WU, Jingzhou City (CN); Yancheng ZHENG, Jingzhou City (CN); Fuchang YOU, Jingzhou City (CN)

(73) Assignee: YANGTZE UNIVERSITY, Jingzhou City (CN)

(21) Appl. No.: 18/731,982

(22) Filed: Jun. 3, 2024

(30) Foreign Application Priority Data
Dec. 19, 2023 (CN) 202311763732.1

(51) Int. Cl. C10M 149/16; C08G 14/14

(52) U.S. Cl. CPC C10M 149/16; C08G 14/14; C10M 2217/042

(57) ABSTRACT

Provided are a non-sulfonated melamine resin viscosity reducer for a drilling fluid and a preparation method thereof. The non-sulfonated melamine resin viscosity reducer for the drilling fluid includes the following raw materials in parts by mass: 100 parts to 150 parts of water, 80 parts to 100 parts of melamine, 20 parts to 30 parts of formaldehyde, 50 parts to 80 parts of a tannin extract, 40 parts to 60 parts of lignin, 20 parts to 40 parts of maleic anhydride, 0.1 parts to 0.3 parts of a catalyst, 1 part to 3 parts of triethanolamine (TEA), and 10 parts to 20 parts of alcoholamine; wherein the alcoholamine is one or more selected from the group consisting of monoethanolamine (MEA), diethanolamine (DEA), diglycolamine (DGA), isopropanolamine (IPA), and diisopropanolamine (DIPA).

### CROSS REFERENCE TO RELATED APPLICATION

This patent application claims the benefit and priority of Chinese Patent Application No. 2023117637321 filed with the China National Intellectual Property Administration on Dec. 19, 2023, the disclosure of which is incorporated by reference herein in its entirety as part of the present application.

### TECHNICAL FIELD

The present disclosure relates to the technical field of oilfield chemistry in petroleum drilling engineering, and in particular to a non-sulfonated melamine resin viscosity reducer for a drilling fluid and a preparation method thereof.

### BACKGROUND

As the petroleum exploration and development continue to move toward development of deep oil and gas, high-temperature deep wells have become the mainstream for future oil and gas exploration and development. During drilling of deep wells and ultra-deep wells, the high temperature and high pressure existing underground pose huge challenges to the performance of drilling fluids. Under high temperature, the insufficient temperature resistance of drilling fluid treatment agents will cause the thickening or viscosity loss of the drilling fluid, while in high-pressure formation environments, drilling fluids with a higher drilling fluid density is required to balance formation pressure. Therefore, the viscosity control of high-density drilling fluids has always been a big problem. Especially when drilling into mudstone formations, the drilling fluid is intruded with clay, causing the viscosity of the drilling fluid to rise sharply and even making it difficult to flow, thereby forcing the drilling work to be suspended.

In order to solve the problems of high temperature resistance and high density of high-temperature deep-well drilling fluids, viscosity reducers are generally used to ensure stable performance of the drilling fluid or to reduce its viscosity. Traditional viscosity reducers are mainly modified from natural products such as iron-chromium lignosulfonate, sulfonated tannins, and sulfonated tannin extracts. These viscosity reducers either contain heavy metals or are sulfonated materials containing sulfur. Another part of the viscosity reducers are copolymerized from monomers containing sulfonated groups, such as sulfonated styrene-maleic anhydride copolymer, sodium allylsulfonate (AS), and 2-acrylamido-2-methylpropanesulfonic acid (AMPS) copolymer, which still contain sulfur element. As environmental protection requirements become increasingly stringent, the application of sulfur-containing sulfonated materials in drilling fluids has gradually been restricted, seriously restricting the technological progress of high-temperature and high-density water-based drilling fluids.

### SUMMARY

In view of this, an object of the present disclosure is to provide a non-sulfonated melamine resin viscosity reducer for a drilling fluid and a preparation method thereof. In the present disclosure, the non-sulfonated melamine resin viscosity reducer for a drilling fluid shows a desirable viscosity-reducing effect and does not contain sulfur.

To achieve the above object, the present disclosure provides the following technical solutions:

Provided is a non-sulfonated melamine resin viscosity reducer for a drilling fluid, which is prepared from raw materials including, in parts by mass:

100 parts to 150 parts of water, 80 parts to 100 parts of melamine, 20 parts to 30 parts of formaldehyde, 50 parts to 80 parts of a tannin extract, 40 parts to 60 parts of lignin, 20 parts to 40 parts of maleic anhydride, 0.1 parts to 0.3 parts of a catalyst, 1 part to 3 parts of triethanolamine (TEA), and 10 parts to 20 parts of alcoholamine; where the alcoholamine is one or more selected from the group consisting of monoethanolamine (MEA), diethanolamine (DEA), diglycolamine (DGA), isopropanolamine (IPA), and diisopropanolamine (DIPA).

In some embodiments, the formaldehyde is a formaldehyde aqueous solution with a concentration of 35 wt % to 40 wt %.

In some embodiments, the tannin extract is one or more selected from the group consisting of a Myrica rubra tannin extract, a valonea tannin extract, and a Mangium tannin extract.

In some embodiments, the catalyst is hexamethylenetetramine (HMTA).

Also provided is a method for preparing the non-sulfonated melamine resin viscosity reducer for a drilling fluid, including the following steps:
mixing the water, the formaldehyde, the catalyst, the melamine, the tannin extract, the lignin, and the TEA to obtain a mixture; and subjecting the mixture to polycondensation to obtain a polycondensation product solution;
mixing the polycondensation product solution and the maleic anhydride to obtain a mixed material; and subjecting the mixed material to first amidation to obtain an amidation product solution; and
mixing the amidation product solution and the alcoholamine to obtain an admixture; and subjecting the admixture to second amidation to obtain the non-sulfonated melamine resin viscosity reducer for the drilling fluid.

In some embodiments, mixing the water, the formaldehyde, the catalyst, the melamine, the tannin extract, the lignin, and the TEA is conducted by:
subjecting the water, the formaldehyde, and the catalyst to first mixing to obtain a first mixed solution;
adding the melamine into the first mixed solution, and conducting second mixing to obtain a second mixed solution; and
adding the tannin extract, the lignin, and the TEA into the second mixed solution in sequence, and conducting third mixing.

In some embodiments, the polycondensation is conducted at a temperature of 60° C. to 70° C. for 3 h to 4 h.

In some embodiments, the first amidation is conducted at a temperature of 60° C. to 70° C. for 0.5 h to 1 h.

In some embodiments, mixing the amidation product solution and the alcoholamine is conducted for 1 h to 1.5 h.

In some embodiments, the second amidation is conducted at a temperature of 150° C. to 170° C. for 8 h to 12 h.

The present disclosure provides a non-sulfonated melamine resin viscosity reducer for a drilling fluid, which is prepared from raw materials including, in parts by mass: 100 parts to 150 parts of water, 80 parts to 100 parts of melamine, 20 parts to 30 parts of formaldehyde, 50 parts to 80 parts of a tannin extract, 40 parts to 60 parts of lignin, 20 parts to 40 parts of maleic anhydride, 0.1 parts to 0.3 parts of a catalyst, 1 part to 3 parts of TEA, and 10 parts to 20 parts of alcoholamine; where the alcoholamine is one or more selected from the group consisting of MEA, DEA, DGA, IPA, and DIPA. In the present disclosure, the melamine, tannin extract, and lignin undergo polycondensation under the action of formaldehyde to form polycondensation macromolecules. A cyclic structure of the melamine could improve a rigidity of the polycondensation macromolecules and provide guarantee for temperature resistance of the viscosity reducer. Moreover, the polycondensation of the tannin extract, lignin, and melamine further enriches the molecular structure and improves the molecular weight of the macromolecular. When clay or other viscosity-increasing solid particles in the drilling fluid absorb water, the aqueous phase in mobile phases is relatively reduced, resulting in that the internal friction between particles increases, with an increase in viscosity as macroscopic manifestation. The non-sulfonated melamine resin viscosity reducer of the present disclosure could be directly adsorbed on clay particles or other solid particles, releasing water as the mobile phase, thereby reducing the viscosity of the drilling fluid. In the present disclosure, the TEA provides an organic base during the polycondensation to ensure that the polycondensation could be conducted under alkaline conditions. The maleic anhydride and the amino group of the melamine undergo hydrogen replacement amidation, thereby adding exposed carboxyl groups on the melamine. The exposed carboxyl group of the maleic anhydride in the macromolecule formed by the polycondensation undergoes amidation with the amino group of the alcoholamine, and a resulting amide group has desirable adsorption properties and could synergize with other treatment agents in the drilling fluid to further improve the temperature resistance. In addition, the exposed hydroxyl groups of the alcoholamine further enhance the hydrophilicity of the melamine resin, making it easier to disperse in water-based drilling fluids.

In the present disclosure, the non-sulfonated melamine resin viscosity reducer for the drilling fluid shows a desirable viscosity-reducing effect, high temperature resistance, and a wide application range, and does not contain sulfur element, thus overcoming the problem that existing sulfonated viscosity reducers are difficult to meet environmental protection requirements. Example results show that the non-sulfonated melamine resin viscosity reducer of the present disclosure has a temperature resistance of up to 240° C. and a viscosity reduction rate of not less than 90%, and exhibits a filtrate loss reduction effect, with a high-temperature and high-pressure filtrate loss of less than 25 mL.

### DETAILED DESCRIPTION OF THE EMBODIMENTS

The present disclosure provides a non-sulfonated melamine resin viscosity reducer for a drilling fluid, which is prepared from raw materials including, in parts by mass:
100 parts to 150 parts of water, 80 parts to 100 parts of melamine, 20 parts to 30 parts of formaldehyde, 50 parts to 80 parts of a tannin extract, 40 parts to 60 parts of lignin, 20 parts to 40 parts of maleic anhydride, 0.1 parts to 0.3 parts of a catalyst, 1 part to 3 parts of triethanolamine (TEA), and 10 parts to 20 parts of alcoholamine;
where the alcoholamine is one or more selected from the group consisting of monoethanolamine (MEA), diethanolamine (DEA), diglycolamine (DGA), isopropanolamine (IPA), and diisopropanolamine (DIPA).

In the present disclosure, unless otherwise specified, all raw materials are commercially available products well known to those skilled in the art.

In the present disclosure, in parts by mass, the raw materials for preparing the non-sulfonated melamine resin viscosity reducer for the drilling fluid includes 100 parts to 150 parts, and preferably 120 parts to 150 parts of the water. In some embodiments, the water is deionized water.

In the present disclosure, based on the mass parts of the water, the raw materials for preparing the non-sulfonated melamine resin viscosity reducer for the drilling fluid includes 20 parts to 30 parts, and preferably 25 parts to 30 parts of the formaldehyde. In some embodiments, the formaldehyde is a formaldehyde aqueous solution with a concentration of 35 wt % to 40 wt % (i.e., 35 wt % to 40 wt % formaldehyde aqueous solution), and preferably a formaldehyde aqueous solution with a concentration of 36 wt % (i.e., 36 wt % formaldehyde aqueous solution).

In the present disclosure, based on the mass parts of the water, the raw materials for preparing the non-sulfonated melamine resin viscosity reducer for the drilling fluid includes 0.1 parts to 0.3 parts, and preferably 0.1 parts to 0.2 parts of the catalyst. In some embodiments, the catalyst is HMTA.

In the present disclosure, based on the mass parts of the water, the raw materials for preparing the non-sulfonated melamine resin viscosity reducer for the drilling fluid includes 80 parts to 100 parts, and preferably 90 parts to 100 parts of the melamine. In some embodiments, melamine is an extremely important basic chemical raw material and has been widely used in home decoration and building materials. However, the use of the melamine is still blank in the field of oil and gas field drilling, and there are few research reports, especially in the use of drilling fluid viscosity reducers.

In the present disclosure, based on the mass parts of the water, the raw materials for preparing the non-sulfonated melamine resin viscosity reducer for the drilling fluid includes 50 parts to 80 parts, and preferably 60 parts to 70 parts of the tannin extract. In some embodiments, the tannin extract is one or more selected from the group consisting of a Myrica rubra tannin extract, a valonea tannin extract, and a Mangium tannin extract, and preferably is a mixture of the Myrica rubra tannin extract, the valonea tannin extract, and the Mangium tannin extract. In some embodiments, when the tannin extract is a mixture of the Myrica rubra tannin extract, the valonea tannin extract, and the Mangium tannin extract, a mass ratio of the Myrica rubra tannin extract, the valonea tannin extract, and the Mangium tannin extract is in a range of (30-50):(30-40):(10-40), and preferably 30:30:40.

In the present disclosure, based on the mass parts of the water, the raw materials for preparing the non-sulfonated melamine resin viscosity reducer for the drilling fluid includes 40 parts to 60 parts, and preferably 40 parts to 50 parts of the lignin.

In the present disclosure, based on the mass parts of the water, the raw materials for preparing the non-sulfonated melamine resin viscosity reducer for the drilling fluid includes 1 part to 3 parts, and preferably 1 part to 2 parts of the TEA.

In the present disclosure, based on the mass parts of the water, the raw materials for preparing the non-sulfonated melamine resin viscosity reducer for the drilling fluid includes 20 parts to 40 parts, and preferably 20 parts to 30 parts of the maleic anhydride.

In the present disclosure, based on the mass parts of the water, the raw materials for preparing the non-sulfonated melamine resin viscosity reducer for the drilling fluid includes 10 parts to 20 parts, and preferably 10 parts to 15 parts of the alcoholamine. In some embodiments, the alcoholamine is one or more selected from the group consisting of MEA, DEA, DGA, IPA, and DIPA, and preferably is one selected from the group consisting of the DEA, DGA, and DIPA.

The present disclosure further provides a method for preparing the non-sulfonated melamine resin viscosity reducer for the drilling fluid, including the following steps:
mixing the water, the formaldehyde, the catalyst, the melamine, the tannin extract, the lignin, and the TEA to obtain a mixture; and subjecting the mixture to polycondensation to obtain a polycondensation product solution;
mixing the polycondensation product solution and the maleic anhydride to obtain a mixed material; and subjecting the mixed material to first amidation to obtain an amidation product solution; and
mixing the amidation product solution and the alcoholamine to obtain an admixture; and subjecting the admixture to second amidation to obtain the non-sulfonated melamine resin viscosity reducer for the drilling fluid.

In the present disclosure, the water, the formaldehyde, the catalyst, the melamine, the tannin extract, the lignin, and the TEA are mixed to obtain a mixture; and the mixture is subjected to polycondensation to obtain a polycondensation product solution.

In some embodiments, mixing the water, the formaldehyde, the catalyst, the melamine, the tannin extract, the lignin, and the TEA is conducted by:
subjecting the water, the formaldehyde, and the catalyst to first mixing to obtain a first mixed solution;
adding the melamine into the first mixed solution, and conducting second mixing to obtain a second mixed solution; and
adding the tannin extract, the lignin, and the TEA into the second mixed solution in sequence, and conducting third mixing.

In some embodiments, the first mixing is conducted under stirring until the water, the formaldehyde, and the catalyst are mixed to be uniform. In some embodiments, the melamine is added slowly, and the second mixing is conducted until the melamine is evenly dispersed in the water. In some embodiments, the third mixing is conducted under stirring, and the third mixing is conducted for 1 h to 2 h.

Since the melamine is insoluble in water, the present disclosure adopts the above mixing method to dissolve the melamine. First, a uniformly dispersed solution of melamine is prepared, and then other raw materials and materials that make TEA easier to dissolve or disperse in water are added thereto, such that the raw materials could be mixed to be uniform and the polycondensation could be accelerated in an alkaline environment.

In some embodiments, the polycondensation is conducted at a temperature of 60° C. to 70° C., and preferably 65° C. In some embodiments, the polycondensation is conducted for 3 h to 4 h, and preferably 3.5 h. In the present disclosure, the melamine, tannin extract, and lignin are subjected to polycondensation under the action of formaldehyde to form polycondensation macromolecules. The catalyst is beneficial to promote the polycondensation, and the cyclic structure of the melamine could improve a rigidity of the polycondensation macromolecules and provide guarantee for temperature resistance of the viscosity reducer. Moreover, the polycondensation of the tannin extract, lignin, and melamine further expands the structure of the macromolecular. When clay or other viscosity-increasing solid particles in the drilling fluid absorb water, the aqueous phase in mobile phases is relatively reduced, resulting in that the internal friction between particles increases, with an increase in viscosity as macroscopic manifestation. Melamine resin viscosity reducer could be directly adsorbed on clay particles or other solid particles, releasing water as the mobile phase, thereby reducing the viscosity of the drilling fluid. In the present disclosure, the TEA provides an organic base during polycondensation to ensure that the polycondensation is conducted under alkaline conditions.

After the polycondensation product solution is obtained, the polycondensation product solution is mixed with the maleic anhydride to obtain a mixed material, and the mixed material is subjected to first amidation to obtain an amidation product solution. In some embodiments, the maleic anhydride is slowly added into the polycondensation product solution. In some embodiments, the first amidation is conducted at a temperature of 60° C. to 70° C., and preferably 65° C. for 0.5 h to 1 h. In the present disclosure, the maleic anhydride and the remaining amino groups of the melamine undergo hydrogen replacement amidation; thus, exposed carboxyl groups on the melamine is increased.

After the amidation product solution is obtained, the amidation product solution is mixed with the alcoholamine to obtain an admixture, and the admixture is subjected to second amidation to obtain the non-sulfonated melamine resin viscosity reducer for the drilling fluid. In some embodiments, the alcoholamine is added into the amidation product solution, and subjected to mixing to obtain a viscous pre-product. In some embodiments, the mixing is conducted for 1 h to 1.5 h under stirring. In some embodiments, the viscous pre-product is discharged into a tray, and the tray containing the viscous pre-product is placed in an oven and subjected to the second amidation. In some embodiments, the second amidation is conducted at a temperature of 150° C. to 170° C., and preferably 160° C. In some embodiments, the second amidation is conducted for 8 h to 12 h, and preferably 10 h. The viscous pre-product is dried while undergoing the second amidation. In the present disclosure, during the second amidation, the exposed carboxyl group of the maleic anhydride in the macromolecule formed by polycondensation reacts with the amino group of the alcoholamine, and a resulting amide group after the reaction has desirable adsorption properties and could synergize with other treatment agents in the drilling fluid to further improve the temperature resistance. In addition, the exposed hydroxyl groups of the alcoholamine further enhance the hydrophilicity of the melamine resin, making it easier to disperse in water-based drilling fluids.

In some embodiments, the method further includes after the second amidation, cooling a resulting reaction product and then grinding to pass through a 120-mesh sieve.

To further describe the present disclosure, the non-sulfonated melamine resin viscosity reducer for the drilling fluid and the preparation method thereof provided by the present disclosure are described in detail below with reference to examples. However, these examples should not be construed as limitations to the protection scope of the present disclosure.

### Example 1

A non-sulfonated melamine resin viscosity reducer for a drilling fluid was prepared by raw materials consisting of (in parts by mass):

150 parts of water, 80 parts of melamine, 30 parts of formaldehyde, 50 parts of a tannin extract, 60 parts of lignin, 20 parts of maleic anhydride, 0.3 parts of a catalyst, 1 part of TEA, and 20 parts of alcoholamine; where the water was deionized water, the formaldehyde was a 36 wt % formaldehyde aqueous solution, the tannin extract was a mixture of a Myrica rubra tannin extract, a valonea tannin extract, and a Mangium tannin extract at a mass ratio of 3:3:4, the catalyst was HMTA, and the alcoholamine was MEA.

The non-sulfonated melamine resin viscosity reducer was prepared by the following steps:

First, the water, formaldehyde, and catalyst were added into a three-necked flask under stirring and mixed well, and the melamine was slowly added thereto and mixed until the melamine was completely and evenly dispersed in the water. Then, the tannin extract and lignin were added thereto, and the TEA was added thereto and stirred for 2 h. Then, a resulting mixture was heated to 70° C. and subjected to polycondensation for 4 h to obtain a polycondensation product solution.

Then, the maleic anhydride was slowly added into the three-necked flask containing the polycondensation product solution, and the maleic anhydride and the remaining amino groups of melamine were subjected to amidation for 0.5 h at a constant temperature of 70° C.

Then, the alcoholamine was added into the three-necked flask and stirred for 1 h to obtain a viscous pre-product, and then the viscous pre-product was discharged into a tray.

Finally, the tray containing the viscous pre-product was dried in an oven at 170° C. for 8 h. The viscous pre-product was subjected to amidation while drying to obtain a reaction product. Then, the reaction product was cooled and ground into a powder to pass through a 120-mesh sieve to obtain the non-sulfonated melamine resin viscosity reducer.

### Example 2

A non-sulfonated melamine resin viscosity reducer for a drilling fluid was prepared by raw materials consisting of (in parts by mass):

100 parts of water, 100 parts of melamine, 20 parts of formaldehyde, 80 parts of a tannin extract, 40 parts of lignin, 40 parts of maleic anhydride, 0.1 parts of a catalyst, 3 parts of TEA, and 10 parts of alcoholamine; where the water was deionized water, the formaldehyde was a 36% formaldehyde aqueous solution, the tannin extract was a mixture of a Myrica rubra tannin extract, the catalyst was HMTA, and the alcoholamine was DEA.

The non-sulfonated melamine resin viscosity reducer was prepared by the following steps:

First, the water, formaldehyde, and catalyst were added into a three-necked flask under stirring and mixed well, and the melamine was slowly added thereto and mixed until the melamine was completely and evenly dispersed in the water. Then, the tannin extract and lignin were added thereto, and the TEA was added thereto and stirred for 1 h. Then, a resulting mixture was heated to 70° C. and subjected to polycondensation for 3 h to obtain a polycondensation product solution.

Then, the maleic anhydride was slowly added into the three-necked flask containing the polycondensation product solution, and the maleic anhydride and the remaining amino groups of melamine were subjected to amidation for 1 h at a constant temperature of 60° C.

Then, the alcoholamine was added into the three-necked flask and stirred for 1.5 h to obtain a viscous pre-product, and then the viscous pre-product was discharged into a tray.

Finally, the tray containing the viscous pre-product was dried in an oven at 150° C. for 12 h. The viscous pre-product was subjected to amidation while drying to obtain a reaction product. Then, the reaction product was cooled and ground into a powder to pass through a 120-mesh sieve to obtain the non-sulfonated melamine resin viscosity reducer.

### Example 3

A non-sulfonated melamine resin viscosity reducer for a drilling fluid was prepared by raw materials consisting of (in parts by mass):

120 parts of water, 90 parts of melamine, 25 parts of formaldehyde, 60 parts of a tannin extract, 50 parts of lignin, 30 parts of maleic anhydride, 0.2 parts of a catalyst, 2 parts of TEA, and 15 parts of alcoholamine; where the water was deionized water, the formaldehyde was a 36% formaldehyde aqueous solution, the tannin extract was a mixture of a valonea tannin extract, the catalyst was HMTA, and the alcoholamine was DIPA.

The non-sulfonated melamine resin viscosity reducer was prepared by the following steps:

First, the water, formaldehyde, and catalyst were added into a three-necked flask under stirring and mixed well, and the melamine was slowly added thereto and mixed until the melamine was completely and evenly dispersed in the water. Then, the tannin extract and lignin were added thereto, and the TEA was added thereto and stirred for 1.5 h. Then, a resulting mixture was heated to 65° C. and subjected to polycondensation for 3.5 h to obtain a polycondensation product solution.

Then, the maleic anhydride was slowly added into the three-necked flask containing the polycondensation product solution, and the maleic anhydride and the remaining amino groups of melamine were subjected to amidation for 1 h at a constant temperature of 65° C.

Then, the alcoholamine was added into the three-necked flask and stirred for 1 h to obtain a viscous pre-product, and then the viscous pre-product was discharged into a tray.

Finally, the tray containing the viscous pre-product was dried in an oven at 160° C. for 10 h. The viscous pre-product was subjected to amidation while drying to obtain a reaction product. Then, the reaction product was cooled and ground into a powder to pass through a 120-mesh sieve to obtain the non-sulfonated melamine resin viscosity reducer.

### Example 4

A non-sulfonated melamine resin viscosity reducer for a drilling fluid was prepared by raw materials consisting of (in parts by mass):

150 parts of water, 90 parts of melamine, 20 parts of formaldehyde, 70 parts of a tannin extract, 60 parts of lignin, 40 parts of maleic anhydride, 0.3 parts of a catalyst, 3 parts of TEA, and 20 parts of alcoholamine; where the water was deionized water, the formaldehyde was a 36% formaldehyde aqueous solution, the tannin extract was a mixture of a Mangium tannin extract, the catalyst was HMTA, and the alcoholamine was DGA.

The non-sulfonated melamine resin viscosity reducer was prepared by the following steps:

First, the water, formaldehyde, and catalyst were added into a three-necked flask under stirring and mixed well, and the melamine was slowly added thereto and mixed until the melamine was completely and evenly dispersed in the water. Then, the tannin extract and lignin were added thereto, and the TEA was added thereto and stirred for 2 h. Then, a resulting mixture was heated to 70° C. and subjected to polycondensation for 4 h to obtain a polycondensation product solution.

Then, the maleic anhydride was slowly added into the three-necked flask containing the polycondensation product solution, and the maleic anhydride and the remaining amino groups of melamine were subjected to amidation for 1 h at a constant temperature of 70° C.

Then, the alcoholamine was added into the three-necked flask and stirred for 1.5 h to obtain a viscous pre-product, and then the viscous pre-product was discharged into a tray.

Finally, the tray containing the viscous pre-product was dried in an oven at 170° C. for 12 h. The viscous pre-product was subjected to amidation while drying to obtain a reaction product. Then, the reaction product was cooled and ground into a powder to pass through a 120-mesh sieve to obtain the non-sulfonated melamine resin viscosity reducer.

### COMPARATIVE EXAMPLES

Sulfonated tannin was used as the viscosity reducer.

The performance of the non-sulfonated melamine resin viscosity reducers obtained in the examples were evaluated:

(I) The non-sulfonated melamine resin viscosity reducers obtained in the above examples were evaluated according to the evaluation method in the following bentonite muds, and the performance test was conducted according to the apparent viscosity test method in GB/T16783.1-2014 “Petroleum and natural gas industries-Field testing of drilling fluids—Part 1: Water-based fluids”.

### Experimental Process

A basic formulation consists of: 100 mL fresh water+12 g bentonite+0.3 g sodium hydroxide+1.0 g sodium carbonate+2 g viscosity reducer of the example (or comparative example). The above basic formulation was compared with a basic formulation without adding the viscosity reducer of the example.

A weighted formulation consists of: 100 mL fresh water+6 g bentonite+0.5 g sodium hydroxide+1.5 g sodium carbonate+2 g viscosity reducer of the example (or comparative example)+barite, where the barite is in such an amount that the weighed formulation has a density of 2.3 g/cm³. The above weighted formulation was compared with a weighted formulation without adding the viscosity reducer of the example.

The experimental results are shown in Table 1:

TABLE 1
Viscosity-reducing properties of the non-sulfonated
viscosity reducers in bentonite muds

| | | | | | | | The flow |
|---|---|---|---|---|---|---|---|
| | | | | | | | characteristic |
| | Viscosity | | | | | | of mud after |
| Sample | reducers | T | State | AV | LTLP | JNL | aging |
| Basic | 0 | 200 | after aging for | 136 | 28.2 | | Extremely |
| formulation | | | 24 h | | | | viscous |
| | Example 1 | 200 | after aging for | 12 | 14.6 | 91.2 | Excellent |
| | | | 24 h | | | | fluidity |
| | Example 2 | 200 | after aging for | 10 | 12.8 | 92.6 | Excellent |
| | | | 24 h | | | | fluidity |
| | Example 3 | 200 | after aging for | 11 | 14.4 | 91.9 | Excellent |
| | | | 24 h | | | | fluidity |
| | Example 4 | 200 | after aging for | 10 | 15.2 | 92.6 | Excellent |
| | | | 24 h | | | | fluidity |
| | Comparative | 200 | after aging for | 18 | 21.5 | 86.8 | Excellent |
| | Example | | 24 h | | | | fluidity |
| Weighted | 0 | 240 | after aging for | 148 | 38.4 | | Almost |
| formulation | | | 24 h | | | | non-fluid |
| | Example 1 | 240 | after aging for | 14 | 8.8 | 90.5 | Excellent |
| | | | 24 h | | | | fluidity |
| | Example 2 | 240 | after aging for | 13 | 10.6 | 91.2 | Excellent |
| | | | 24 h | | | | fluidity |
| | Example 3 | 240 | after aging for | 14 | 10.2 | 90.5 | Excellent |
| | | | 24 h | | | | fluidity |
| | Example 4 | 240 | after aging for | 14 | 11.4 | 90.5 | Excellent |
| | | | 24 h | | | | fluidity |
| | Comparative | 240 | after aging for | 27 | 18.7 | 81.8 | Excellent |
| | Example | | 24 h | | | | fluidity |

As shown in Table 1, the non-sulfonated melamine resin viscosity reducers of the examples of the present disclosure and the sulfonated tannin of the comparative example both have a desirable viscosity-reducing effect in the bentonite muds. The viscosity reduction and filtrate loss reduction effects in the examples of the present disclosure are better than those of the sulfonated tannin of the comparative example, and the sulfonated tannin of the comparative example is limited in application since they contain sulfur element.

(II) The non-sulfonated melamine resin viscosity reducers of the above examples were added into the high-temperature water-based drilling fluid system commonly used in drilling for evaluation. The rheological properties and filtrate loss properties of the drilling fluid were evaluated according to GB/T16783.1-2014 “Petroleum and natural gas industries-Field testing of drilling fluids-Part 1: Water-based fluids”.

### Experimental Process

High-temperature water-based drilling fluid system consists of: 100 mL fresh water+2 g bentonite+0.5 g sodium hydroxide+0.5 g sodium carbonate+1.0 g high-temperature tackifier+2.0 g high-temperature polymer filtrate loss agent+5 g potassium chloride+barite+15 g mudstone-contaminated drilling fluid+3 g the viscosity reducer of the example (or comparative example), where the barite is in such an amount that the high-temperature water-based drilling fluid system has a density of 2.3 g/cm³. The above high-temperature water-based drilling fluid system was compared with a high-temperature water-based drilling fluid system without adding the viscosity reducer of the example.

The experimental results are shown in Table 2:

TABLE 2
Performance of the non-sulfonated viscosity reducers in
the high-temperature water-based drilling fluid system

| | | | | | | | | The flow |
|---|---|---|---|---|---|---|---|---|
| Viscosity | | | | | | | | characteristic of |
| reducers | T | State | PV | YP | Φ3 | LTLP | HTHP | mud after aging |
| 0 | 240 | after aging | 98 | 32 | 25 | 10.2 | 42.5 | Thick and almost |
| | | for 24 h | | | | | | non-fluid |
| Example 1 | 240 | after aging | 48 | 12 | 12 | 5.4 | 19.2 | Extremely viscous |
| | | for 24 h | | | | | | |
| Example 2 | 240 | after aging | 44 | 10 | 9 | 5.0 | 23.8 | Excellent fluidity |
| | | for 24 h | | | | | | |
| Example 3 | 240 | after aging | 45 | 9 | 8 | 4.8 | 21.4 | Excellent fluidity |
| | | for 24 h | | | | | | |
| Example 4 | 240 | after aging | 50 | 11 | 10 | 4.6 | 20.6 | Excellent fluidity |
| | | for 24 h | | | | | | |
| Comparative | 240 | after aging | 56 | 18 | 13 | 6.8 | 28.8 | Excellent fluidity |
| Example | | for 24 h | | | | | | |

As shown in Table 2, the non-sulfonated melamine resin viscosity reducers of the examples of the present disclosure have desirable compatibility in high-temperature water-based drilling fluid system. When the drilling fluid is contaminated by mudstone, the drilling fluid is thickened seriously. At this time, adding additional viscosity reducers could effectively improve the viscosity performance of the drilling fluid, reduce the viscosity, and reduce the filtrate loss.

Notes: the meaning of each parameter in Table 1 and Table 2 was as follows:
T: aging temperature of the drilling fluid, ° C.;
AV: apparent viscosity of the drilling fluid, mPa·s;
PV: plastic viscosity of the drilling fluid, mPa·s;
YP: yield point of the drilling fluid, Pa;
Φ3:3-turn reading of a six-speed rotational viscometer, dimensionless;
LTLP: the cumulative filtrate loss for 30 min obtained for all drilling fluid samples using the standard API Filter Press at 0.7 MPa, mL;
HTHP: high-temperature and high-pressure filtrate loss of the drilling fluid (3.5 MPa, T, 30 min), mL;
JNL: AV reduction rate before and after adding the viscosity reducers to the formulation, %.

The above described are merely preferred embodiments of the present disclosure rather than limitations to the present disclosure in any form. It should be noted that those skilled in the art may further make several improvements and modifications without departing from the principle of the present disclosure, but such improvements and modifications should be deemed as falling within the scope of the present disclosure.

What is claimed is:

1. A non-sulfonated melamine resin viscosity reducer for a drilling fluid, which is prepared from raw materials comprising, in parts by mass:
100 parts to 150 parts of water, 80 parts to 100 parts of melamine, 20 parts to 30 parts of formaldehyde, 50 parts to 80 parts of a tannin extract, 40 parts to 60 parts of lignin, 20 parts to 40 parts of maleic anhydride, 0.1 parts to 0.3 parts of a catalyst, 1 part to 3 parts of triethanolamine (TEA), and 10 parts to 20 parts of alcoholamine;
wherein the alcoholamine is one or more selected from the group consisting of monoethanolamine (MEA), diethanolamine (DEA), diglycolamine (DGA), isopropanolamine (IPA), and diisopropanolamine (DIPA).

2. The non-sulfonated melamine resin viscosity reducer for the drilling fluid of claim 1, wherein the formaldehyde is a formaldehyde aqueous solution with a concentration of 35 wt % to 40 wt %.

3. The non-sulfonated melamine resin viscosity reducer for the drilling fluid of claim 1, wherein the tannin extract is one or more selected from the group consisting of a Myrica rubra tannin extract, a valonea tannin extract, and a Mangium tannin extract.

4. The non-sulfonated melamine resin viscosity reducer for the drilling fluid of claim 1, wherein the catalyst is hexamethylenetetramine (HMTA).

5. A method for preparing the non-sulfonated melamine resin viscosity reducer for the drilling fluid of claim 1, comprising the following steps:
mixing the water, the formaldehyde, the catalyst, the melamine, the tannin extract, the lignin, and the TEA to obtain a mixture; and subjecting the mixture to polycondensation to obtain a polycondensation product solution;
mixing the polycondensation product solution and the maleic anhydride to obtain a mixed material; and subjecting the mixed material to first amidation to obtain an amidation product solution; and
mixing the amidation product solution and the alcoholamine to obtain an admixture; and subjecting the admixture to second amidation to obtain the non-sulfonated melamine resin viscosity reducer for the drilling fluid.

6. The method of claim 5, wherein mixing the water, the formaldehyde, the catalyst, the melamine, the tannin extract, the lignin, and the TEA is conducted by:
subjecting the water, the formaldehyde, and the catalyst to first mixing to obtain a first mixed solution;
adding the melamine into the first mixed solution, and conducting second mixing to obtain a second mixed solution; and
adding the tannin extract, the lignin, and the TEA into the second mixed solution in sequence, and conducting third mixing.

7. The method of claim 5, wherein the polycondensation is conducted at a temperature of 60° C. to 70° C. for 3 h to 4 h.

8. The method of claim 5, wherein the first amidation is conducted at a temperature of 60° C. to 70° C. for 0.5 h to 1 h.

9. The method of claim 5, wherein mixing the amidation product solution and the alcoholamine is conducted for 1 h to 1.5 h.

10. The method of claim 5, wherein the second amidation is conducted at a temperature of 150° C. to 170° C. for 8 h to 12 h.

11. The method of claim 5, wherein the formaldehyde is a formaldehyde aqueous solution with a concentration of 35 wt % to 40 wt %.

12. The method of claim 5, wherein the tannin extract is one or more selected from the group consisting of a Myrica rubra tannin extract, a valonea tannin extract, and a Mangium tannin extract.

13. The method of claim 5, wherein the catalyst is hexamethylenetetramine (HMTA).
